(19) United States
(12) Patent Application Publication
(10) Pub. No.: US 2005/0164629 A1
(43) Pub. Date: Jul. 28, 2005

(54) Satellite broadcasting converter, and detector circuit used therein

(75) Inventor: Masato Hirai, Kanagawa (JP)

Correspondence Address: MCGINN & GIBB, PLLC, 8321 OLD COURTHOUSE ROAD, SUITE 200, VIENNA, VA, 22182-3817, US

(73) Assignee: NEC Electronics Corporation, Kawasaki-Shi (JP)

(21) Appl. No.: 11/043,152

(22) Filed: Jan. 27, 2005

(30) Foreign Application Priority Data
Jan. 28, 2004 (JP) 2004-020118

(51) Int. Cl. H04B 1/06

(52) U.S. Cl. 455/3.02; 455/310

(57) ABSTRACT

In a broadcasting satellite (BS) converter adapted to be connected to a BS tuner and fed with a power supply voltage signal from the broadcasting satellite tuner, a receiver circuit is controlled by a control circuit. The receiver circuit includes a mixer, a first local frequency oscillator for outputting a first local frequency signal to the mixer to thereby convert BS signals, included in a low frequency band, into intermediate frequency signals, and a second local frequency oscillator for outputting a second local frequency signal to the mixer to thereby convert BS signals, included in a high frequency band, into intermediate frequency signals. The control circuit includes a detector circuit for detecting is whether a band switching pulse signal is superimposed on the power supply voltage signal, and a selector circuit for selectively driving only one of the first and second local oscillators in accordance with a detection result obtained in the detector circuit. The detector circuit includes a phase-lock loop circuit for the detection of the band switching pulse signal.

### BACKGROUND OF THE INVENTION

1. Field of the Invention

The present invention relates to a converter, called a broadcasting satellite (BS) converter in this field, which is used to receive BS signals in a satellite broadcasting system, and more particularly relates to an improvement of a control circuit incorporated in the BS converter to select either a high frequency band or a low frequency band included in a reception frequency band used in the satellite broadcasting system.

2. Description of the Related Art

In recent years, a reception frequency band used in a satellite broadcasting system has been widened to accommodate digitization of the satellite broadcasting system and an increase in the number of channels thereof. For example, the widened reception frequency band is defined as one between 10.7 GHz and 12.75 GHz, and it is impossible to receive all broadcasting satellite (BS) signals (microwaves), included in the widen reception frequency band, with only one parabola antenna and one BS converter. In other words, it is necessary to prepare two parabola antennas and two BS converters before all the BS signals can be received. Namely, the reception frequency band is divided into a low frequency band of 10.7 GHz to 11.7 GHz and a high frequency band of 11.7 GHz to 12.75 GHz, and the two parabola antennas and two BS converters are arranged for the respective low and high frequency bands.

JP-A-H08-293812, corresponding to U.S. Pat. No. 5,649,311, discloses a prior art BS converter which is constituted so as to receive all the BS signals included in the reception frequency band. Namely, according to JP-A-H08-293812, it is possible to receive all the BS signals with a single parabola antenna and BS converter.

This prior art BS converter is provided with a reception circuit for receiving all the BS signals, and a control circuit for controlling the reception circuit. The reception circuit includes a mixer, and first and second local oscillators connected to the mixer. The first local oscillator inputs a first local frequency signal to the mixer, and the second local oscillator inputs a second local frequency signal to the mixer. The first local frequency signal features a lower frequency than that of the second local frequency signal. The control circuit selects which local oscillator should be driven.

In particular, when a television set, which is connected to the BS converter through the intermediary of a broadcasting satellite (BS) and a coaxial cable, is tuned to a channel to receive a BS signal included in the low frequency-band of 10.7 GHz to 11.7 GHz, only the first local oscillator is driven by the control circuit so that the BS signals included in the low frequency band of 10.7 GHz to 11.7 GHz are converted into intermediate frequency signals featuring a frequency of 950 MHz to 2150 MHz.

On the other hand, when the television set is tuned to a channel to receive a BS signal included in the high frequency band of 11.7 GHz to 12.75 GHz, only the second local oscillator is driven by the control circuit so that the BS signals included in the high frequency band of 11.7 GHz to 12.75 GHz are converted into intermediate frequency signals featuring a frequency of 950 MHz to 2150 MHz.

Thus, by using the prior art BS converter, it is possible to receive all the BS signals by the single parabola antenna and BS converter. Nevertheless, the prior art BS converter is not satisfactory in that it is impossible to obtain reliable operation.

In particular, when the television set is tuned to a channel to receive a BS signal included in the high frequency band of 11.7 GHz to 12.75 GHz, a band switching pulse signal is superimposed on a power supply voltage signal which is fed from the BS tuner to the BS converter through the coaxial cable. The control circuit includes a detector circuit for detecting whether the band switching pulse signal is superimposed on the power supply voltage signal, and a selector circuit for selectively driving the second local oscillator when the band switching pulse signal is detected by the detector circuit.

However, in this prior art, the detector circuit is susceptible to large amplitude noise, such as a spike noise or the like. As a result, a malfunction of the detector circuit may occur. Namely, the control circuit may mistakenly select which local oscillator should be driven, as explained in detail hereinafter.

### SUMMARY OF THE INVENTION

Therefore, an object of the present invention is to provide a broadcasting satellite (BS) converter used to receive BS signals in a satellite broadcasting system, which is constituted such that it is possible to obtain a satisfactory reliable operation.

Another object of the present invention is to provide a detector circuit used in such a BS.converter, which is not susceptible to various noises.

Yet another object of the present invention is to provide a control circuit that controls a receiver circuit included in such a BS converter.

In accordance with a first aspect of the present invention, there is provided a broadcasting satellite (BS) converter adapted to be connected to a broadcasting satellite tuner and fed with a pulse signal from the broadcasting satellite tuner. The BS converter comprises a receiver circuit including a mixer, and a plurality of local oscillators connected to the mixer to convert broadcasting satellite signals into intermediate frequency signals. The BS converter further comprises a control circuit that controls the receiver circuit. The control circuit includes a detector circuit that detects whether a band switching pulse signal is superimposed on the pulse signal, and the detector circuit includes a phase-lock loop circuit for the detection of the band switching pulse signal. The control circuit further includes a selector circuit that selectively drives one of the local oscillators in accordance with a detection is result obtained in the detector circuit.

The detector circuit may further include a high pass filter that is constituted such that the band switching pulse signal is allowed to pass therethrough, a level detector circuit that detects a peak voltage of the band switching pulse signal so as to wave-shape the band switching pulse signal, the wave-shaped band switching pulse signal being input to the phase-lock loop circuit. Preferably, the level detector circuit includes a comparator featuring a hysteresis characteristic for the wave-shaping of the band switching pulse signal.

The phase-locked loop circuit may include a free-running oscillation type voltage control oscillator that outputs an oscillation signal having a frequency which is near to a frequency of the band switching pulse signal, a phase detector that compares a phase of the band switching pulse signal with a phase of the oscillation sign a to thereby detect a phase difference therebetween, and a loop filter that outputs a voltage signal in accordance with the phase difference. The voltage signal is fed back to the free-running oscillation type voltage control oscillator such that a locked state is established in the phase-locked loop circuit.

The detector circuit may further include a comparator circuit that compares the voltage signal, output from the loop filter, with a reference voltages to thereby detect whether the locked state is established in the phase-locked loop circuit. Preferably, the comparator circuit includes a variable voltage sources that varies the reference voltage.

The phase-locked loop circuit may further include a 180°-phase shifter that produces a 180°-phase-shifted oscillation signal from the oscillation signal. In this case, the 180°-phase-shifted oscillation signal is input to the phase detector to thereby establish the locked state in which the phase of the band switching pulse signal is advanced or retarded by 90° with respect to the phase of the oscillation signal. The phase detector may be constituted as a double-balanced-multiplier.

The detector circuit may further include a window-type comparator circuit that compares the voltage signal, output from the loop filter, with a first predetermined reference voltage and a second predetermined reference voltage to thereby detect whether the locked state is established in the phase-locked loop circuit. Preferably, the window-type comparator circuit includes a first variable voltage sources that varies the first reference voltage, and a second variable voltage source that varies the second reference voltage.

In accordance with a second aspect of the present invention, there is provided a detector circuit that detects whether a band switching pulse signal is superimposed on a power supply voltage signal fed from a broadcasting satellite tuner to a receiver circuit of a broadcasting satellite converter. The detector circuit comprises a phase locked loop circuit that is constituted such that a locked state is established when the band switching pulse signal is input thereto.

In this second aspect, the detector circuit may further comprise a high pass filter that is constituted such that the band switching pulse signal is allowed to pass therethrough, and a level detector circuit that detects a peak voltage of the band switching pulse signal so as to wave-shape the band switching pulse signal, with the wave-shaped band switching pulse signal being input to the phase locked loop circuit.

In accordance with a third aspect of the present invention, there is provided a control circuit that controls a plurality of local oscillators, included in a receiver circuit of a broadcasting satellite converter, with a band switching pulse signal superimposed on a pulse signal fed from a broadcasting satellite tuner to the receiver circuit. The control circuit comprises a detector circuit that detects whether the band switching pulse signal is superimposed on the pulse signal, the detector circuit including a phase locked loop circuit that is constituted such that a locked state is established when the band switching pulse signal is input thereto, and a selector circuit that selectively drives one of the local oscillators in accordance with a detection result obtained in the detector circuit.

### BRIEF DESCRIPTION OF THE DRAWINGS

The above object and other objects will be more clearly understood from the description set forth below, with reference to the accompanying drawings, wherein:

FIG. 1 is a block diagram of a prior art broadcasting satellite converter;

FIG. 2 is a circuit diagram of a prior art detector circuit used in the prior art broadcasting satellite converter shown in FIG. 1;

FIG. 3 is a graph showing a frequency/amplitude characteristic of a band pass filter used in the detector circuit shown in FIG. 2;

FIG. 4 is a circuit diagram of a detector circuit, used in an embodiment of a broadcasting satellite converter lo according to the present invention, which is substituted for the prior art detector circuit shown in FIG. 1;

FIG. 5 is a wiring diagram of a phase detector used in a phase lock loop circuit of the detector circuit shown in FIG. 4; and

FIG. 6 is a graph showing a frequency/amplitude characteristic of the phase lock loop circuit shown in FIG. 4.

### DESCRIPTION OF THE PREFERRED EMBODIMENTS

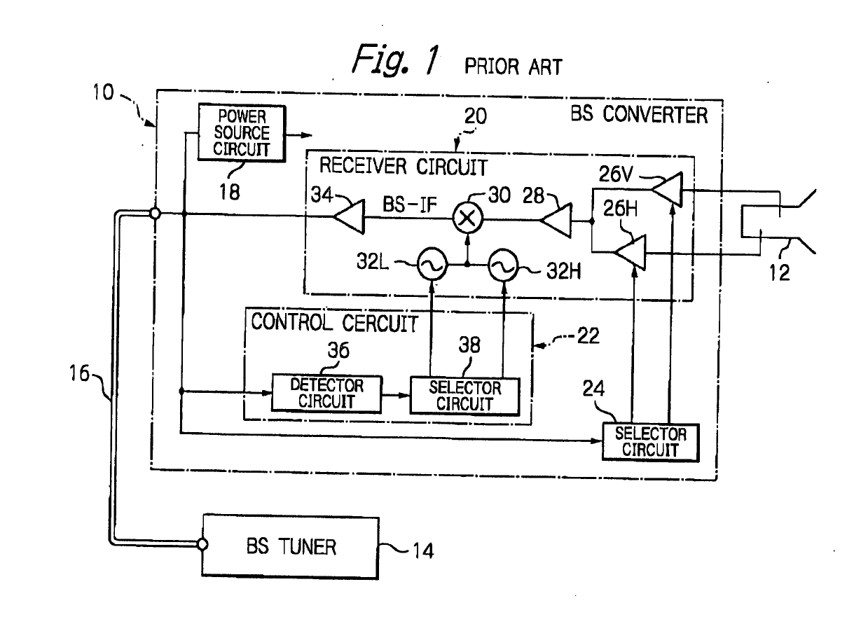

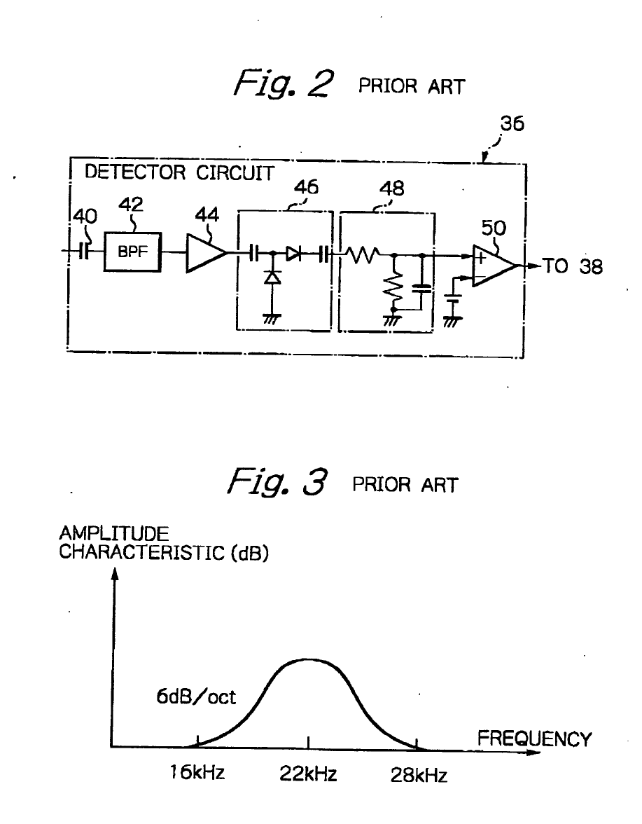

Before descriptions of an embodiment of the present invention, for better understanding of the present invention, a prior art broadcasting satellite (BS) converter, as disclosed in JP-A-H08-293812, will be now explained with reference to FIGS. 1 and 2.

This prior art BS converter, generally indicated by reference 10, is provided with a feed horn 12 associated with an exterior parabola antenna (not shown), and is connected to an interior broadcasting satellite (BS) tuner 14 through a coaxial cable 16.

The BS converter 10 comprises a power source circuit 18, a receiver circuit 20, a control circuit 22, and a selector circuit 24. In operation, a power supply voltage signal is fed from the BS tuner 14 to the BS converter 10 through the coaxial cable 16, and is input to the power source circuit 18 and the selector circuit 24. Although the power supply voltage signal is switched between a low voltage (e.g. 13 volts) and a high voltage (e.g. 18 volts) for the reasons stated in detail hereinafter, the power source circuit 18 always generates a constant power supply voltage (e.g. 4 volts) for operating the receiver circuit 20, the control circuit 22, and the selector circuit 24.

As shown in FIG. 1, the receiver circuit 20 includes a set of first and second primary amplifiers 26V and 26H, a secondary amplifier 28, a mixer 30, a set of first and second local oscillators 32L and 32H, and an amplifier 34.

Broadcasting satellite (BS) signals (microwaves), which are transmitted from a satellite, are converged on the feed horn 12 by the parabola antenna, and each of the BS signals is separated into a vertically polarized wave and a horizontally polarized wave. The vertically-polarized waves are fed to the first primary amplifier 26V, and are amplified and output to the secondary amplifier 28 as BS signals featuring the vertical polarization. Also, the horizontally-polarized waves are fed to the second primary amplifier 26H, and are amplified and output to the secondary amplifier 28 as BS signals featuring the horizontal polarization. Note, as already stated above, the BS signals are included in a widened reception frequency band which is defined as one between 10.7 GHz and 12.75 GHz.

In operation, only one of the first and second primary amplifiers 26V and 26H is driven, and the selector circuit 24 selects which primary amplifier 26V or 26H should be driven.

In particular, for example, while a television set (not shown), connected to the BS tuner 14, is tuned to a channel to receive a BS signal featuring the vertical polarization, the power supply voltage signal, input to the selector switch 24, is switched from the high voltage (18 volts) to the low voltage (13 volts). At this time, a first drive control signal, which is output from the selector circuit 24 to the first primary amplifier 26V, is maintained at a high level so that the first primary amplifier 26V is driven On the other hand, a second drive control signal, which is output from the selector circuit 24 to the second primary amplifier 26H, is maintained at a low level so that the second primary amplifier 26H is not driven. Namely, when the power supply voltage signal is switched from the high voltage (18 volts) to the low voltage (13 volts), only the first primary amplifier 26V is driven by the selector circuit 24.

When the television set, connected to the BS tuner 14, is tuned to a channel to receive a BS signal featuring the is horizontal polarization, the power supply voltage signal, input to the selector switch 24, is switched from the low voltage (13 volts) to the high voltage (18 volts). At this time, the first drive control signal, output from the selector circuit 24 to the first primary amplifier 26V, is changed from the high level to a low level so that the driving of the first primary amplifier 26V is stopped. On the other hand, the second drive control signal, output from the selector circuit 24 to the second primary amplifier 26H, is changed from the low level to a high level so that the second primary amplifier 16H is driven. Namely, when the power supply voltage is switched from the low voltage (13 volts) to the high voltage (18 volts), only the second primary amplifier 26H is driven the selector circuit 24.

In short, the power supply voltage signal, which is switched between the low voltage (13 volts) and the high voltage (18 volts), serves as a pulse signal for selecting which primary amplifier 26V or 26H should be driven.

Either the BS signals featuring the vertical polarization or the BS signals featuring the horizontal polarization are fed to the secondary amplifier 28, and then the amplified BS signals are fed to the mixer 20 in which the BS signals are mixed with one of a first local frequency signal and a second local frequency signal which are output from the respective first and second local oscillators 32L and 32H. The first local frequency signal has a lower frequency than that of the second local frequency signal. When the BS signals are mixed with the first local frequency signal output from the first local oscillator 32L, a part of the BS signals, which are included in a low frequency band of 10.7 GHz to 11.7 GHz, are converted into intermediate frequency signals BS-IF (FIG. 1). When the BS signals are mixed with the second local frequency signal output from the second local oscillator 32H, the remaining part of the BS signals, which are included in a high frequency band of 11.7 GHz to 12.75 GHz, are converted into intermediate frequency signals BS-IF (FIG. 1).

In either event, the intermediate frequency signals BS-IF are fed from the mixer 10 to the amplifier 34, and the amplified intermediate frequency signals BS-IF are fed to the BS tuner 14 through the coaxial cable 16. Note, for example, the intermediate frequency signals BS-IF has a frequency of 1 GHz.

The control circuit 22 selects which local oscillator 32L or 32H should be driven. As shown in FIG. 1, the control circuit 22 includes a detector circuit 36 for detecting whether a band switching pulse signal is superimposed on the power supply voltage signal (13 volts or 18 volts), and a selector circuit 38 for selecting which local amplifier 32L or 32H should be driven on the basis of a detection result obtained in the detector circuit 36. Note, the band switching pulse signal is defined as a tone signal having a frequency of 22±4 kHz.

In particular, when the television set, connected to the BS tuner 14, is tuned to a channel to receive a BS signal included in the low frequency band of 10.7 GHz to 11.7 GHz, the band switching pulse signal is not superimposed on the power supply voltage signal (13 volts or 18 volts) in the BS tuner 14, and thus the band switching pulse signal cannot be detected by the detector circuit 36. At this time, a first drive control signal, which is output from the selector circuit 38 to the first local frequency oscillator 32L, is maintained at a high level so that the first local frequency oscillator 32L is driven. On the other hand, a second drive control signal, which is output from the selector circuit 38 to the second local frequency oscillator 32H, is maintained at a low level so that the second local frequency oscillator is 32H is not driven.

In short, while the band switching pulse signal is not superimposed on the power supply voltage signal (13 volts or 18 volts), only the first local frequency oscillator 32L is driven so that the BS signals, included in the low frequency band of 10.7 GHz to 11.7 GHz, are converted into the intermediate frequency signals BS-IF.

When the television set, connected to the BS tuner 14, is tuned to a channel to receive a BS signal included in the high frequency band of 11.7 GHz to 12.75 GHz, the band switching pulse signal is superimposed on the power supply voltage signal (13 volts or 18 volts) in the BS tuner 14, and thus the band switching pulse signal can be detected by the detector circuit 36. At this time, the first drive control signal, output from the selector circuit 38 to the first local frequency oscillator 32L, is changed from the high level to a low level so that the driving of the first local frequency oscillator 32L is stopped. On the other hand, the second drive control signal, output from the selector circuit 38 to the second local frequency oscillator 32H, is changed from the low level to a high level so that the second local frequency oscillator 32H is driven.

In short, while the band switching pulse signal is superimposed on the power supply voltage signal (13 volts or 18 volts), only the second local frequency oscillator 32H is driven so that the BS signals, included in the high frequency band of 11.7 GHz to 12.75 GHz, are converted into the intermediate frequency signals BS-IF.

FIG. 2 shows a circuit diagram of the detector circuit 36. As shown in this drawing, the detector circuit 36 includes a capacitor 40, a band pass filter 42, an amplifier 44, a rectifier circuit 46, a low pass filter 48, and a comparator 50.

For example, when the band switching pulse signal having the frequency of 22±4 kHz is superimposed on the power supply voltage signal (13 volts or 18 volts) in the BS tuner 14 by tuning the television set to a channel to receive a BS signal included in the high frequency band of 11.7 GHz to 12.75 GHz, the band switching pulse signal is input together with the intermediate frequency signals BS-IF to the band pass filter 42 through the capacitor 40, but only the band switching pulse signal is allowed to pass through the band pass filter 42. Then, the band switching pulse signal is input to the amplifier 44 so as to be amplified to a given voltage level.

The amplified band switching pulse signal is rectified by the rectifier circuit 46, and then an amplitude of the rectified band switching pulse signal is detected by the low pass filter 48. Namely, both the rectifier circuit 46 and the low pass filter 48 function as an amplitude detector for detecting the amplitude of the band switching pulse signal, so that the detected amplitude is output as an amplitude voltage signal from the low pass filter 48 to the comparator

In the comparator 50, the amplitude voltage signal is compared with a predetermined reference voltage. The amplitude voltage signal, derived from the band switching pulse signal, is higher than the reference voltage of the comparator 50, so that a high level signal is output from the comparator 50 to the selector circuit 38. At this time, the drive control signal, output from the selector circuit 38 to the second local oscillator 32H, is changed from the low level lo to the high level, whereas the drive control signal, output from the selector circuit 38 to the first local oscillator 32L, is changed from the high level to the low level.

Thus, as stated above, only the second local oscillator 32H is driven so that the conversion of the BS signals, included in the high frequency band of 11.7 GHz to 12.75 GHz, into the intermediate frequency signals BS-IF is carried out.

Of course, when the band switching pulse signal having the frequency of 22±4 kHz is not superimposed on the power supply voltage signal (13 volts or 18 volts), i.e. when the television set is tuned to a channel to receive a BS signal included in the low frequency band of 10.7 GHz to 11.7 GHz, the amplitude voltage signal, output from the low pass filter 48, is lower than the reference voltage of the comparator 50, so that a low level signal is output from the comparator 50 to the selector circuit 38. At this time, the drive control signal, output from the selector circuit 38 to the first local oscillator 32L, is changed from the low level to the high level, whereas the drive control signal, output from the selector circuit 38 to the second local oscillator 32H, is changed from the high level to the low level.

Thus, as stated above, only the first local oscillator 32L is driven so that the conversion of the BS signals, included in the low frequency band of 10.7 GHz to 11.7 GHz, into the intermediate frequency signals BS-IF is carried out.

In this prior art, the band pass filter 42 may have a frequency/amplitude characteristic as shown in a graph of FIG. 3. As is apparent from this graph, each of the side bands of the amplitude characteristic features a gradual slope, and thus the detector circuit 36 is susceptible to a noise having a large amplitude, such as a spike noise or the like, which is generated when the power supply voltage signal is switched between the low voltage (e.g. 13 volts) and the high voltage (e.g. 18 volts) or which is generated from internal combustion engines of motorcycles or automobiles. Of course, when the spike noise is introduced in the detector circuit 36, a malfunction of the detector circuit 36 may occur. Namely, the is control circuit 22 may mistakenly select which local oscillator 32L or 32H should be driven.

Also, in addition to the side bands of the amplitude characteristic featuring the gradual slope, since the band switching pulse signal has a small peak value of 0.6±0.2 volts, a sensitivity of the detector circuit 36 for detecting the band switching pulse signal (22±4 kHz) is inferior.

In short, in the prior art BS converter, it is impossible to obtain a satisfactory reliable operation of the BS converter 10.

Note, in the above-mentioned prior art BS converter 10, although a low pass filter may be substituted for the band pass filter 42, the low pass filter is also susceptible to a noise having a large amplitude, such a spike noise or the like.

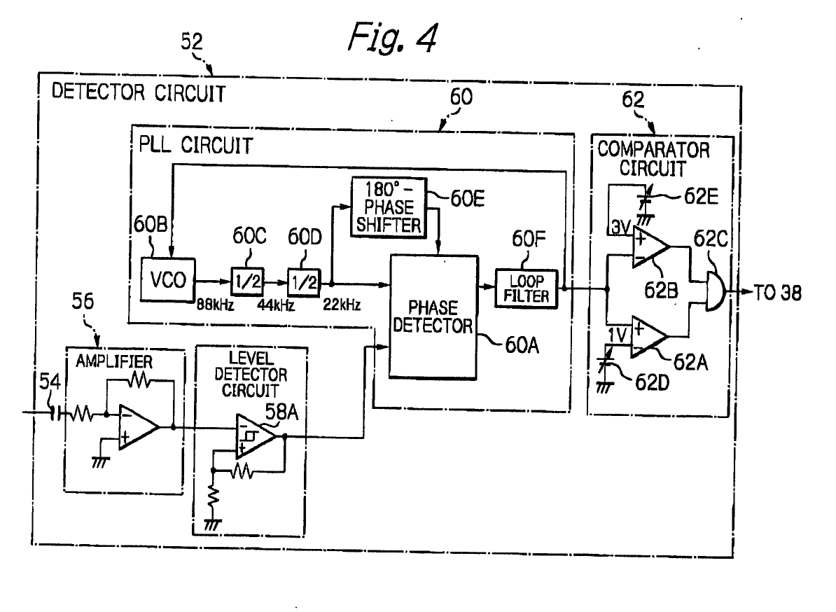

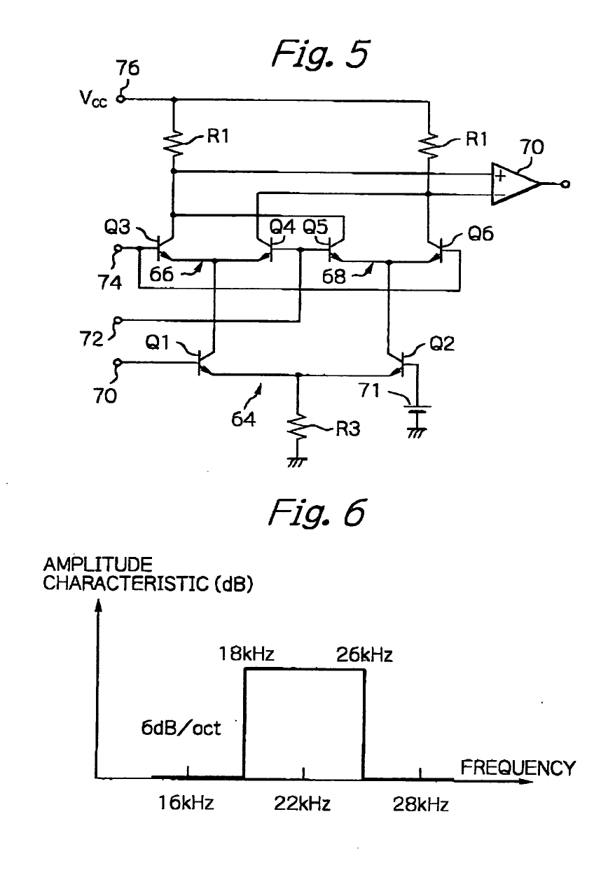

Next, with reference to FIGS. 4 and 5, an embodiment of a broadcasting satellite (BS) converter according to the present invention is explained below.

When the embodiment of the BS converter according to the present invention is illustrated in a block diagram, it is substantially identical to the block diagram shown in FIG. 1, except that a detector circuit, generally indicated by reference 52, is substituted for the detector circuit 36.

As shown in FIG. 4, the detector circuit 52 includes a capacitor 54, an amplifier 56, a level detector circuit 58, a phase-locked loop (PLL) circuit 60, and a comparator circuit 62.

For example, when the band switching pulse signal having the frequency of 22±4 kHz is superimposed on the power supply voltage signal (13 volts or 18 volts) in the BS tuner 14 by tuning the television set to a channel to receive a BS signal included in the high frequency band of 11.7 GHz to 12.75 GHz, the band switching pulse signal is input together with the intermediate frequency signals BS-IF to the amplifier 56 through the capacitor 54. Then, the band switching pulse signal is input to the amplifier 44 so as to be amplified to a given voltage level, and the amplified band switching pulse signal is input to the level detector 58. Note, both the capacitor 54 and the amplifier 56 form a high pass filter.

The level detector circuit 58 has a comparator 58A featuring a hysteresis characteristic, and the amplified band switching pulse signal is compared with a predetermined threshold voltage by the comparator 58A. The predetermined threshold voltage is lower than a peak voltage of the amplified band switching pulse signal, and thus a pulse signal, having substantially the same frequency as that (22±4 kHz) of the band switching pulse signal, is output from the level detector circuit 58 to the PLL circuit 60. Thus, although the pulse signal output from the level detector circuit 58 may be referred to as a band switching pulse signal, this band switching pulse signal is free from the various noises involved in the original band switching pulse signal, due to the hysteresis characteristic of the comparator 58A. In short, the band switching pulse signal is wave-shaped by the comparator 58A, and the wave-shaped band switching pulse signal is input to the PLL circuit 60.

The PLL circuit 60 has a phase detector 60A, a voltage control oscillator (VCO) 60B, a first frequency divider 60C, a second frequency divider 60D, a 180°-phase shifter 60E, and a loop filter (low pass filter).

As shown in FIG. 4, the band switching pulse signal output from the level detector circuit 58 is input to the phase detector 60A of the PLL circuit 60.

The VCO 60B is of a free-running oscillation type, and outputs a first oscillation signal having a frequency, which is near to 88 kHz, to the-first frequency divider 60C, in which the first oscillation signal (88 kHz) is converted into a is second oscillation signal having a frequency which is near to 44 kHz Then, the second oscillation signal (44 kHz) is input from the first frequency divider 60C to the second frequency divider 60D, in which the second oscillation signal (44 kHz) is further converted into a third oscillation signal having a frequency which is near to 22 kHz, and the third oscillation signal (22 kHz) is input from the second frequency divider 60D to the phase detector 60A.

As shown in FIG. 4, the third oscillation signal (22 kHz) is input from the second frequency divider 60D to the 180°-phase shifter 60E, in which the phase of the input third oscillation signal (22 kHz) is shifted by 180° with respect to the phase of the original oscillation signal (22 kHz) output from the second frequency divider 60D, to thereby produce a 180°-phase-shifted oscillation signal. Then, the produced 180°-phase-shifted pulse signal (22 kHz) is input from the 180°-phase shifter 60E to the phase detector 60A.

As shown in FIG. 5, for example, the phase detector 60A may be constituted as a double-balanced-multiplier, which includes a first differential amplifier 64 having two transistors Q1 and Q2 forming a differential pair, a second differential amplifier 66 having two transistors Q3 and Q4 forming a differential pair, a third differential amplifier 68 having two transistors Q5 and Q6 forming a differential pair, and a comparator 70. The transistors Q1 to Q6 and the comparator CMP are arranged and connected to each other, as shown in FIG. 5.

The base of the transistor Q1 is connected to an input terminal 72 for inputting the band switching pulse signal (22±4 kHz) from the level detector circuit 58. Both the bases of the transistors Q4 and Q5 are connected to an input terminal 74 for inputting the third oscillation signal (22 kHz) from the second frequency divider 60D. Both the bases of the transistors Q3 and Q6 are connected to an input terminal 76 for inputting the 180°-phase-shifted pulse signal (22 kHz) from the 180°-phase shifter 60E. Optionally, the respective 180°-phase-shifted pulse signal (22 kHz) and third oscillation signal (22 kHz) may be input to the input terminals 72 and 74.

Also, in FIG. 5, reference 76 indicates an input terminal for inputting a power supply voltage V_{CC} from the power source circuit 18 (FIG. 1), and the power supply voltage V_{CC} is applied to the collectors of the transistors Q3 and Q6 through respective resistors R1 and R2. The emitters of the transistor Q1 and Q2 are grounded through a resistor R3. The base of the transistor Q2 is connected to a voltage source 71. The output terminal of the comparator 70 is connected to the loop filter 60F (FIG. 4).

With the arrangement of the phase detector 60A as shown in FIG. 5, when the band switching pulse signal (22±4 kHz) is input to the input terminal 70, the PLL circuit 60 is locked to thereby establish a locked state, in which the phase of the band switching pulse signal is advanced or retarded by 90° with respect to the phase of the third oscillation signal (22 kHz) output from the second frequency divider 60D so that a voltage of approximately V_{CC}/2 is output from the loop filter 60F. Namely, the outputting of the voltage of approximately V_{CC}/2 from the loop filter 60F means the detection of the band switching pulse signal (22±4 kHz). For example, if V_{CC}=4 volts, the outputting of the voltage of approximately 2 volts from the loop filter 60F means the detection of the band switching pulse signal (22±4 kHz).

It is determined by the circuit 62 (FIG. 4) whether the voltage of approximately 2 volts is output from the loop pass filter 60F. As shown in FIG. 4, in this embodiment, the comparator circuit 62 is constituted as a window-type is comparator circuit. Namely, the window-type comparator includes a first comparator 62A having a reference voltage of 1 volt, a second comparator 62B having a reference voltage of 3 volts, and an AND-gate 62C. Note, preferably, the respective reference voltages of 1 volt and 3 volts are obtained from variable voltage sources 62D and 62E.

When the voltage, output from the loop filter 60F of the PLL circuit 60 to the window-type comparator circuit 62, falls within a range between the reference voltage (1 volt) of the first comparator 62A and the reference voltage (3 volts) of the second comparator 62B, i.e. when the band switching pulse signal is superimposed on the power supply voltage signal (13 volts or 18 volts), both the first and second comparators 62A and 62B output respective high level signals to the AND-gate 62C, and thus a high level signal is output from the AND-gate 62C to the selector circuit 38 (FIG. 1).

On the other hand, when the voltage, input from the loop filter 60F of the PLL circuit 60 to the window-type comparator circuit 62, is out of the range between the reference voltage (1 volt) of the first comparator 62A and the reference voltage (3 volts) of the second comparator 62B, i.e. when the band switching pulse signal is not superimposed on the power supply voltage signal (13 volts or 18 volts), a low level signal is output from one of the first and second comparators 62A and 62B to the AND-gate 62C, and a high level signal is output from the other comparator (62A or 62B), so that a low level signal is output from the AND-gate 62C to the selector circuit 38 (FIG. 1).

Similar to the above-mentioned prior art BS converter, when the high level signal is input from the AND-gate 62C to the selector circuit 38, i.e. when the band switching pulse signal (22±4 kHz) is superimposed on the power supply voltage signal (13 volts or 18 volts), the drive control signal, output is from the selector circuit 38 to the second local oscillator 32H, is changed from the low level to the high level, whereas the drive control signal, output from the selector circuit 38 to the first local oscillator 32L, is changed from the high level to the low level.

Thus, only the second local oscillator 32H is driven so that the conversion of the BS signals, included in the high frequency band of 11.7 GHz to 12.75 GHz, into the intermediate frequency signals BS-IF is carried out.

On the other hand, when the high level signal is input from the AND-gate 62C to the selector circuit 38, i.e. when the band switching pulse signal (22±4 kHz) is not superimposed on the power supply voltage signal (13 volts or 18 volts), the drive control signal, output from the selector circuit 38 to the first local oscillator 32L, is changed from the low level to the high level, whereas the drive control signal, output from the selector circuit 38 to the second local oscillator 32H, is changed from the high level to the low level.

Thus, only the first local oscillator 32L is driven so that the conversion of the BS signals, included in the low frequency band of 10.7 GHz to 11.7 GHz, into the intermediate frequency signals BS-IF is carried out.

In this embodiment, the PLL circuit 60 may have a frequency/amplitude characteristic as shown in a graph of FIG. 6. As shown in this graph, the frequency/amplitude characteristic features a rectangular profile, the sides of which are defined by the frequencies of 18 kHz and 26 kHz, and thus the detector circuit 52 is not susceptible to various noises, resulting in a satisfactory reliable operation of the BS converter according to the present invention.

Also, according to the present invention, whenever the band switching pulse signal (22±4 kHz) is superimposed on the power supply voltage signal (13 volts or 18 volts), it is possible to ensure the establishment of the locked state in the PLL circuit 60, and thus a sensitivity of the detector circuit 62 for detecting the band switching pulse signal (22±4 kHz) is superior to the case of the above-mentioned prior art BS converter.

In the above-mentioned embodiment of the present invention, although the band switching pulse signal (22±4 kHz) is superimposed on the power supply voltage signal (13 volts or 18 volts), no influence can be exerted on the intermediate frequency signals BS-IF by the superimposed band switching pulse signal, because the frequency of the band switching pulse signal is sufficiently lower than that (950 to 2150 MHz) of the intermediate frequency signal BS-IF.

Finally, it will be understood by those skilled in the art that the foregoing description is of a preferred embodiment of the device, and that various changes and modifications may be made to the present invention without departing from the spirit and scope thereof.

1. A broadcasting satellite converter adapted to be connected to a broadcasting satellite tuner and fed with a pulse signal from said broadcasting satellite tuner, which converter comprises:
a receiver circuit including a mixer, and a plurality of local oscillators connected to said mixer to convert broadcasting satellite signals into intermediate frequency signals; and
a control circuit that controls said receiver circuit,
wherein said control circuit includes;
a detector circuit that detects whether a band switching pulse signal is superimposed on said pulse signal, said detector circuit including a phase-lock loop circuit for the detection of said band switching pulse signal; and
a selector circuit that selectively drives one of said local oscillators in accordance with a detection result obtained in said detector circuit.

2. The broadcasting satellite converter as set forth in claim 1, wherein said detector circuit further includes:
a high pass filter that is constituted such that said band switching pulse signal is allowed to pass therethrough; and
a level detector circuit that detects a peak voltage of said band switching pulse signal so as to wave-shape the band switching pulse signal, the wave-shaped band switching pulse signal being input to said phase-lock loop circuit.

3. The broadcasting satellite converter as set forth in claim 2, wherein said level detector circuit includes a comparator featuring a hysteresis characteristic for the wave-shaping of the band switching pulse signal.

4. The broadcasting satellite converter as set forth in claim 1, wherein said phase-locked loop circuit includes a free-running oscillation type voltage control oscillator that outputs an oscillation signal having a frequency which is near to a frequency of said band switching pulse signal, a phase detector that compares a phase of said band switching pulse signal with a phase of said oscillation signal to thereby detect a phase difference therebetween, and a loop filter that outputs a voltage signal in accordance with said phase difference, and wherein said voltage signal is fed back to said free-running oscillation type voltage control oscillator such that a locked state is established in said phase-locked loop circuit.

5. The broadcasting satellite converter as set forth in is claim 4, wherein said detector circuit further includes a comparator circuit that compares the voltage signal, output from said loop filter, with a reference voltage, to thereby detect whether the locked state is established in said phase-locked loop circuit.

6. The broadcasting satellite converter as set forth in claim 5, wherein said comparator circuit includes a variable voltage sources that varies said reference voltage.

7. The broadcasting satellite converter as set forth in claim 4, wherein said phase-locked loop circuit further includes a 180°-phase shifter that produces a 180°-phase-shifted oscillation signal from said oscillation signal, and wherein said 180°-phase-shifted oscillation signal is input to said phase detector to thereby establish the locked state in which the phase of said band switching pulse signal is advanced or retarded by 90° with respect to the phase of said oscillation signal, said phase detector being constituted as a double-balanced-multiplier.

8. The broadcasting satellite converter as set forth in claim 7, wherein said detector circuit further includes a window-type comparator circuit that compares the voltage signal, output from said loop filter, with a first predetermined reference voltage and a second predetermined reference voltage to thereby detect whether the locked state is established in said phase-locked loop circuit.

9. The broadcasting satellite converter as set forth in claim 8, wherein said window-type comparator circuit includes a first variable voltage sources that varies said first reference voltage, and a second variable voltage source that varies said second reference voltage.

10. A detector circuit that detects whether a band switching pulse signal is superimposed on a pulse signal fed from a broadcasting satellite tuner to a receiver circuit of a broadcasting satellite converter, which detector circuit comprises a phase locked loop circuit that is constituted such that a locked state is established when said band switching pulse signal is input thereto.

11. The detector circuit as set forth in claim 10, further comprising:
a high pass filter that is constituted such that said band switching pulse signal is allowed to pass therethrough; and
a level detector circuit that detects a peak voltage of said band switching pulse signal so as to wave-shape the band switching pulse signal, with the wave-shaped band switching pulse signal being input to said phase locked loop circuit.

12. The detector circuit as set forth in claim 10, wherein, said level detector circuit includes a comparator featuring a hysteresis characteristic for the wave-shaping of the band switching pulse signal.

13. The detector circuit as set forth in claim 10, wherein said phase-locked loop circuit includes a free-running oscillation type voltage control oscillator that outputs an oscillation signal having a frequency which is near to a frequency of said band switching pulse signal, a phase detector that compares a phase of said band switching pulse signal with a phase of said oscillation signal to thereby detect a phase difference therebetween, and a loop filter that outputs a voltage signal in accordance with said phase difference, and wherein said voltage signal is fed back to said free-running oscillation type voltage control oscillator such that the locked state is established in said phase-locked loop circuit.

14. The detector circuit as set forth in claim 10, further comprising a comparator circuit that compares the is voltage signal, output from said loop filter, with a reference voltage to thereby detect whether the locked state is established in said phase-locked loop circuit.

15. The detector circuit as set forth in claim 14, wherein said comparator circuit includes a variable voltage sources that varies said reference voltage.

16. The detector circuit as set forth in claim 13, wherein said phase-locked loop circuit further includes a 180°-phase shifter that produces a 180°-phase-shifted oscillation signal from said oscillation signal, and wherein said 180°-phase-shifted oscillation signal is input to said phase detector to thereby establish the locked state in which the phase of said band switching pulse signal is advanced or retarded by 90° with respect to the phase of said oscillation signal, said phase detector being constituted as a double-balanced-multiplier.

17. The detector circuit as set forth in claim 16, wherein said detector circuit further includes a window-type comparator circuit that compares the voltage signal, output from said loop filter, with a first predetermined reference voltage and a second predetermined reference voltage to thereby detect whether the locked state is established in said phase-locked loop circuit.

18. The detector circuit as set forth in claim 17, wherein said window-type comparator circuit includes a first variable voltage sources that varies said first reference voltage, and a second variable voltage source that varies said second reference voltage.

19. A control circuit that controls a plurality of local oscillators, included in a receiver circuit of a broadcasting satellite converter, with a band switching pulse signal superimposed on a pulse signal fed from a broadcasting satellite tuner to said receiver circuit, which control circuit comprises:
a detector circuit that detects whether the band switching pulse signal is superimposed on said pulse signal, said detector circuit including a phase locked loop circuit that is constituted such that a locked state is established when said band switching pulse signal is input thereto; and
a selector circuit that selectively drives one of said local oscillators in accordance with a detection result obtained in said detector circuit.
